(19) United States
(12) Patent Application Publication
(10) Pub. No.: US 2023/0244384 A1
(43) Pub. Date: Aug. 3, 2023

(54) FIFO MEMORY AND PROCESSING METHOD FOR FIFO MEMORY

(71) Applicant: SHENZHEN PANGO MICROSYSTEMS CO.,LTD., Shenzhen City (CN)

(72) Inventors: Shengwen XIANG, Shenzhen City (CN); Ying LIU, Shenzhen City (CN)

(73) Assignee: SHENZHEN PANGO MICROSYSTEMS CO.,LTD., Shenzhen City (CN)

(21) Appl. No.: 17/906,982

(22) PCT Filed: Mar. 24, 2021
(86) PCT No.: PCT/CN2021/082541

§ 371 Date: Sep. 22, 2022

(30) Foreign Application Priority Data
Oct. 21, 2020 (CN) 202011130749.X

(51) Int. Cl. G06F 3/06; G06F 1/08; G06F 1/24

(52) U.S. Cl. CPC G06F 3/0613; G06F 3/0659; G06F 3/0673; G06F 1/08; G06F 1/24

(57) ABSTRACT

A processing method for a FIFO memory. The FIFO memory comprises a data caching module and an address control module. The processing method comprises: an address control module receives an empty/full state signal of a data caching module (S200); and the address control module adjusts the read-write address difference of the data caching module (S300). In the method, an address control module receives an empty/full state signal of a data caching module and the address control module adjusts the read-write address difference of the data caching module, thereby preventing an abnormality in a FIFO memory caused by pointer collision and ensuring normal data communication

### FIELD OF THE INVENTION

The present application relates to the technical field of communication technology, and more particularly, to a FIFO memory and a processing method for FIFO memory.

### BACKGROUND OF THE INVENTION

The current cross-clock domain processing generally follows a FIFO application method, which sets a fixed FIFO depth and a read-and-write pointer difference. When an abnormal state of the FIFO is detected, a resetting operation is required to restore the FIFO to normal.

The above reset operation has the following insufficiency: after FIFO exception, it does not automatically return to normal quickly, it needs to rely on software to monitor the abnormal state of the FIFO, and then a reset operation is performed to return it to normal, because the monitoring such as software is relatively complicated, the time required for FIFO recovery is relatively long, which in turn affects the normal communication of the link.

### SUMMARY OF THE INVENTION

An object of the present application is to provide a processing method for FIFO memory, when the FIFO is abnormal, it can automatically return to normal.

In order to achieve the above object, the present invention provides a processing method for FIFO memory, in which the FIFO memory includes a data caching module and an address control module, wherein the said processing method comprises the following steps:

the address control module receiving an empty/full state signal of the data caching module; and

the address control module adjusting a read-write address difference of the data caching module.

According one embodiments of the invention, the read-write address difference is set by a register.

Preferably, the address control module sets an initial value of the read address and an initial value of the write address of the data caching module.

The application also provides a FIFO memory comprising a data caching module, an address control module, a write address bus, a read address bus, a write full signal line, and a read empty signal line; wherein

the address control module and the data caching module are electrically connected through the write address bus, the read address bus, the write full signal line and the read empty signal line respectively; and wherein,

the address control module receives an empty/full state signal of the data caching module;

the address control module adjusts a read-write address difference of the data caching module.

In some embodiments of the invention, the read-write address difference is set by a register.

Preferably, the address control module sets an initial value of the read address and an initial value of the write address of the said data caching module.

In some embodiments of the invention, the FIFO memory also comprises a write clock port for inputting a write clock frequency and a read clock port for inputting a read clock frequency; and the read clock port is electrically connected to the data caching module and the address control module respectively; the write clock port is electrically connected to the data caching module and the address control module, respectively; and the read clock frequency and the write clock frequency both have the same frequency but different phases.

In some embodiments of the invention, the FIFO memory also comprises a reset port, an abnormal status indication port; wherein the address control module is electrically connected to the reset port and the abnormal status indication port respectively.

The technical advantages of the present application is that the address control module can adjust the read-write address difference of the data caching module when an address controls module receiving an empty/full state signal of a data caching module by providing a processing method for FIFO memory, thereby preventing an abnormality in a FIFO memory caused by pointer collision and ensuring normal data communication.

### BRIEF DESCRIPTION OF THE DRAWINGS

FIG. 1 is a flowchart of the processing method for FIFO memory in one embodiment of the application; and

FIG. 2 is a structural diagram of the FIFO memory in another embodiment of the application.

### DETAILED DESCRIPTION OF THE INVENTION

The technical solution of the specification will be clearly and completely described in combination with the embodiments and the accompanying drawings so as to make the object, technical solution and advantages of this invention clearer. Obviously, the described embodiments are only a part of this description, but not all of the embodiments. Based on the embodiments, all other modifications obtained by ordinary technicians in the art without creative work shall fall into the scope of protection f the invention. It should be noted that the embodiments and features in the embodiments in the present invention can be combined with each other without conflict.

The terms “first”, “second” and “third” in the description, claims and the drawings are used to distinguish different objects, rather than to describe a specific order. In addition, the term “includes” and any variations thereof are intended to cover non-exclusive inclusion. For example, a process, method, system, product or equipment containing a series of steps or units is not limited to the listed steps or units, but optionally also includes the steps or units not listed, or optionally includes other steps or units fixed to these processes, methods, products or equipment.

The embodiment of the application provides a processing method for FIFO (First Input First Output) memory, which is used for FIFO memory including a data caching module and an address control module.

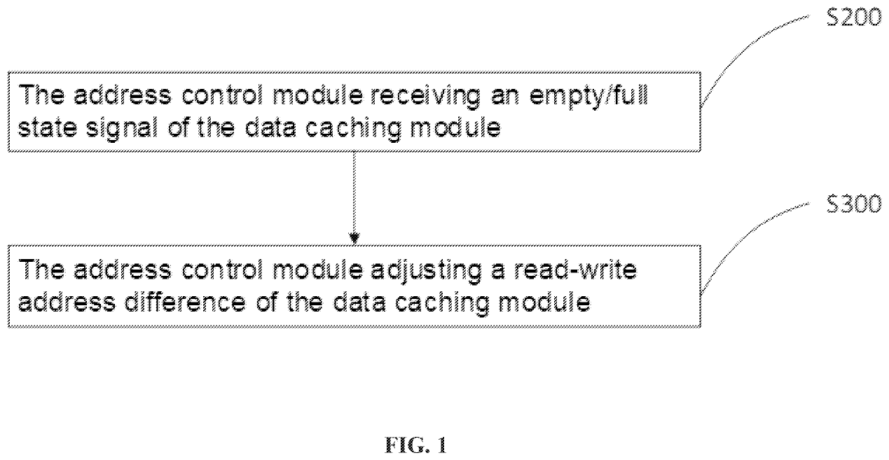

FIG. 1 is a flowchart of the processing method for FIFO memory according to an embodiment of the invention, and the processing method comprises the following steps:

Step S200, the address control module receiving an empty/full state signal of the data caching module; and

Step S300, the address control module adjusting a read-write address difference of the data caching module.

Specifically, the read-write address difference can be set by a register, the adjustment method is detailed as follows: when detecting that the FIFO is empty, the read pointer is kept in a waiting state, that is, no read operation is performed, and when detecting that the FIFO is full, the write pointer is kept in a waiting state, that is, no write operation is performed.

Through the above processing steps, when there is an abnormality in the FIFO memory, the read-write pointer difference of the data caching module is adjusted according to the received empty/full state signal so that the data read and write of the data caching module can be quickly returned to normal.

According to the processing method for FIFO memory of the present application, when the address control module receives an empty/full state signal of the data caching module, the address control module adjusts a read-write address difference of the data caching module, thereby preventing an abnormality in a FIFO memory caused by pointer collision and ensuring normal data communication.

The FIFO memory (data caching module) may be read to be empty or full caused by abnormal conditions such as the relative jitter of the read and write clocks in the FIFO memory. Before performing “Step S200, the address control module receiving an empty/full state signal of the data caching module”, the processing method also comprises step S100, the data caching module detecting the empty/full state of the FIFO memory, and generating an empty/full state signal. The data caching module detects the empty/full state of the FIFO memory in real time, that is to judge whether there is an empty/full exception in the FIFO memory. When an empty/full exception is detected, the data caching module generates an empty/full state signal.

The present application determines that whether the FIFO memory has an empty/full exception by detecting the empty/full state of the FIFO memory in real time, once the empty/full exception is detected, the read and write pointers (read/write pointer) difference of the FIFO memory may be adjusted immediately. Therefore, the FIFO memory exception caused by the pointer collision can be avoided, and the normal communication of data can be ensured.

Specifically, the empty/full state includes a read empty state and a write full state. When a read empty exception (read empty state) is detected, the data caching module generates a read empty state signal (empty state flag); when a full write exception (write full state) is detected, the data caching module generates a write full state signal (full state flag), that is, the empty/full state signal is a read empty state signal/write full state signal.

Specifically, the read empty state can be determined that when the next cycle of the read address is predicted to catch up with the write address and a collision of the read and write address pointers occurs; the write full state can be determined that when the next cycle of the predicted write address will catch up with the read address and a collision of the read and write address pointers occurs.

After the empty/full state signal is generated, the empty/full state signal may be sent to the address control module.

In a preferred embodiment, step S200 can be implemented by the following ways: according to the read empty state signal/write full state signal generated and sent by the data caching module, the address control module receives the read empty state signal/write full state signal of the data cache module.

In a preferred embodiment, step S300, the address control module adjusts the read-write pointer difference of the data caching module, that is, when the address control module receives the empty/full state signal, it adjusts the read-write pointer difference of the data caching module in real time. Adjusting the read-write pointer difference means adjusting the read-write address difference; the read pointer pointing to the next read address means that the read pointer is the read address; the write pointer pointing to the next write address means that the write pointer is the write address.

Further, the read-write address difference can be set by register's parameter. Specifically, the read-write address difference can be set by register's parameter so as to adjust the read-write address difference. The method for setting the parameter of the read-write address difference includes setting the initial value setting of static parameters and resetting the initial value after power-on, optionally configuring an interface through the register which can be realized by dynamically modifying the value assigned to the read-write address difference register address in the working state.

The processing method for FIFO memory according to the present application, detection of the abnormal state of the FIFO memory and adjustment of the read and write pointer difference of the data caching module to quickly return to normal enables no interruption of the communication or unawareness of the abnormal communication by the user.

The present invention also provides a FIFO (First Input First Output) memory, in which the data that enters the FIFO memory first is sent out by the FIFO memory first. The FIFO memory is actually a first-in-first-out dual port memory (caching), that is, the first data entered into the FIFO memory is sent out (shifted out) first.

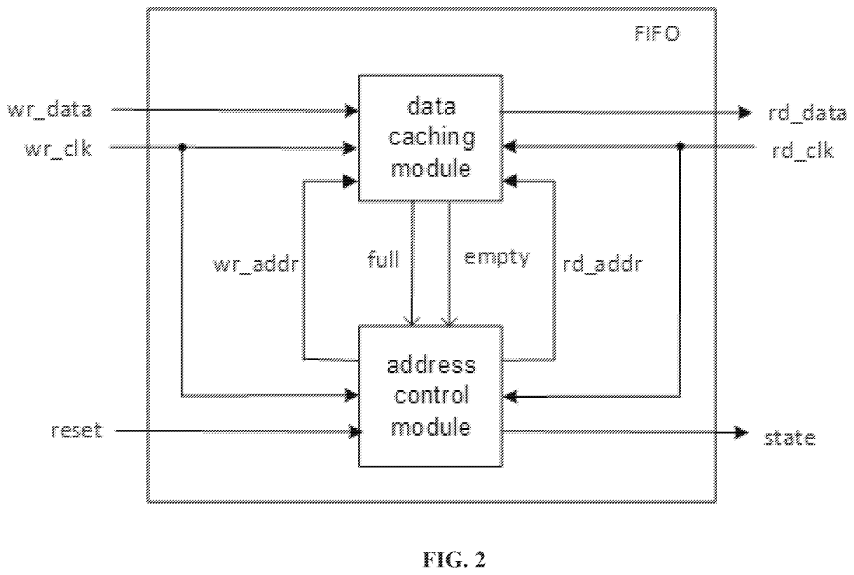

FIG. 2 is a structure diagram of the FIFO memory according to an embodiment of the invention. The FIFO memory comprises a data caching module for writing data to the caching and an address control module for controlling the read and write addresses. The address control module and the data caching module are electrically connected via a write address bus (wr_addr), a read address bus (rd_addr), a write full signal line (full), and a read empty signal line (empty) respectively. The data caching module in the embodiment is implemented by RAM.

In one embodiment, the FIFO memory also comprises the following steps:

Step S200, the address control module receiving an empty/full state signal of the data caching module; and

Step S300, the address control module adjusting a read-write address difference of the data caching module.

Specifically, the read-write address difference can be set by a register, the adjustment method is detailed as follows: when detecting that the FIFO is empty, the read pointer is kept in a waiting state, that is, no read operation is performed, and when detecting that the FIFO bit is full, the write pointer is kept in a waiting state, that is, no write operation is performed.

In a preferred embodiment, the FIFO memory also comprises a write clock port (wr_clk) for inputting a write clock frequency, a read clock port (rd_clk) for inputting a read clock frequency. The read clock port is electrically connected to the data caching module and the address control module respectively, the write clock port is electrically connected to the data caching module and the address control module, respectively. The read clock frequency and the write clock frequency both have the same frequency but different phases.

The FIFO memory also comprises a write data port (wr_data) for writing data into the FIFO memory (data caching module); a read data port (rd_data) for data reading out of the FIFO memory (data caching module), and the data caching module is electrically connected to the write data port and the read data port respectively.

When the FIFO memory is in the initial state of power-on reset, the address control module configures the read address initial value and the write address initial value of the data caching module, that is, the address control module controls setting initial values of both the write address and the read address. The write address is incremented by the clock tick under the write clock domain (write clock frequency), controlling data is written to the data caching module through the write data port, and the read address is incremented by the clock tick under the read clock domain (read clock frequency), controlling data is read out from the data caching module through the read data port.

Specifically, the read address initial value and the write address initial value can be configured by custom, when the depth of the FIFO memory is 8, the read address initial value is 0 and the write address initial value is 4, which ensures that the FIFO memory is written first and then is read. Thus the read and write addresses difference is 4 in the initial state of power-on. If desired, the write address initial value can also be changed to any value ranged from 1 to 7.

When there is an abnormality in the FIFO memory, the read-write pointer difference of the data caching module can be adjusted according to the received empty/full state signal through the above processing steps, rendering that the data read and write of the data caching module can quickly return to normal.

The FIFO memory (data caching module) may be read to be empty or full caused by abnormal conditions such as the relative jitter of the read and write clocks in the FIFO memory. Before performing “Step S200, the address control module receiving an empty/full state signal of the data caching module”, the processing method also comprises step S100, the data caching module detecting the empty/full state of the FIFO memory, and generating an empty/full state signal. The data caching module detects the empty/full state of the FIFO memory in real time, that is to judge whether there is an empty/full exception in the FIFO memory. When an empty/full exception is detected, the data caching module generates an empty/full state signal.

Specifically, the empty/full state includes a read empty state and a write full state. When a read empty exception (read empty state) is detected, the data caching module generates a read empty state signal (empty state flag); when a full write exception (write full state) is detected, the data caching module generates a write full state signal (full state flag), that is, the empty/full state signal is a read empty state signal/write full state signal.

Specifically, the read empty state can be determined that when the next cycle of the read address is predicted to catch up with the write address and a collision of the read and write address pointers occurs; the write full state can be determined that when the next cycle of the predicted write address will catch up with the read address and a collision of the read and write address pointers occurs.

After the empty/full state signal is generated, the empty/full state signal may be sent to the address control module.

In a preferred embodiment, step S200 can be implemented by the following ways: according to the read empty state signal/write full state signal generated and sent by the data caching module, the address control module receives the read empty state signal/write full state signal of the data cache module.

In a preferred embodiment, step S300, the address control module adjusts the read-write pointer difference of the data caching module, that is, when the address control module receives the empty/full state signal, it adjusts the read-write pointer difference of the data caching module in real time. Adjusting the read-write pointer difference means adjusting the read-write address difference; the read pointer pointing to the next read address means that the read pointer is the read address; the write pointer pointing to the next write address means that the write pointer is the write address.

Further, the read-write address difference can be set by register's parameter. Specifically, the read-write address difference can be set by register's parameter so as to adjust the read-write address difference. The method for setting the parameter of the read-write address difference includes setting the initial value setting of static parameters and resetting the initial value after power-on, optionally configuring an interface through the register which can be realized by dynamically modifying the value assigned to the read-write address difference register address in the working state.

In a preferred embodiment, the FIFO memory also comprises a reset port (reset) and an abnormal status indication port (state). The address control module is electrically connected to the reset port and the abnormal status indication port respectively. The historical abnormal state can be extracted through the abnormal status indication port, and historical alarm information formed by the historical abnormal state is reported by the abnormal status indication port.

The write data port, the read data port, the write clock port, the read clock port, the reset port, the abnormal status indication port are the ports for the FIFO memory communicating with external data or signals.

The read address bus, the write address bus, the write full signal line, the read empty signal line are for the internal signal transfer of the FIFO memory.

According to the embodiment of the present application, the abnormal state of the FIFO memory can be detected, and the read and write pointer difference of the data caching module can be adjusted to quickly return to normal, so that the communication is not interrupted or the user is unaware of the abnormal communication. Further, the read and write pointer difference for abnormal adjustment of the FIFO memory is configured through the register, which can be configured for automatic adjustment, or configured for changing the adjusted value, if desired.

The above is only the embodiments of the invention. It should be pointed out that those skilled in the art can make improvements without departing from the creative idea of the application, but these shall fall into the protection scope of the invention.

What is claimed is:

1. A processing method for a FIFO memory comprising a data caching module and an address control module, wherein the processing method comprises the following steps:
the address control module receiving an empty/full state signal of the data caching module; and
the address control module adjusting a read-write address difference of the data caching module.

2. The processing method of claim 1, wherein the read-write address difference is set by a register.

3. The processing method of claim 1, wherein an initial value of the read address and an initial value of the write address of the data caching module is set by the address control module.

4. A FIFO memory comprising a data caching module, an address control module, a write address bus, a read address bus, a write full signal line, and a read empty signal line;
the address control module and the data caching module being electrically connected through the write address bus, the read address bus, the write full signal line and the read empty signal line respectively;
the address control module receiving an empty/full state signal of the data caching module;
the address control module adjusting a read-write address difference of the data caching module.

5. The FIFO memory of claim 4, wherein the read-write address difference is set by a register.

6. The FIFO memory of claim 4, wherein an initial value of the read address and an initial value of the write address of the data caching module is set by the address control module.

7. The FIFO memory of claim 4, wherein the FIFO memory also comprises a write clock port for inputting a write clock frequency and a read clock port for inputting a read clock frequency, in which the read clock port is electrically connected to the data caching module and the address control module respectively, the write clock port is electrically connected to the data caching module and the address control module respectively;
and wherein the read clock frequency and the write clock frequency both have the same frequency but different phases.

8. The FIFO memory according to claim 4, wherein the FIFO memory also comprises a reset port, an abnormal status indication port;
and wherein the address control module is electrically connected to the reset port and the abnormal status indication port respectively.
